(19) United States
(12) Patent Application Publication
(10) Pub. No.: US 2014/0222696 A1
(43) Pub. Date: Aug. 7, 2014

(54) PEER TO PEER NETWORK FOR DISPLAY OF REAL ESTATE INFORMATION

(71) Applicant: NAVIA.COM, LLC, FT. MEYERS, FL (US)

(72) Inventor: CHARLES C ASHBY, NAPLES, FL (US)

(73) Assignee: NAVIA.COM, LLC, FT. MYERS, FL (US)

(21) Appl. No.: 14/049,388

(22) Filed: Oct. 9, 2013

Related U.S. Application Data
(60) Provisional application No. 61/762,270, filed on Feb. 7, 2013.

(51) Int. Cl. G06Q 50/16; G06F 3/0484

(52) U.S. Cl. CPC G06Q 50/16; G06F 3/0484
USPC 705/313

(57) ABSTRACT

A real estate data display system is provided comprising real estate data obtained from an aggregated source of real estate data such as an aggregation of broker listings or an Internet data exchange network (IDX). A repository storage area is provided for receiving first real estate data pertaining to a first geographic region and second real estate data pertaining to a second geographic region. The first real estate data is segmented from the second real estate data within the repository storage area. A first dashboard interface enables a first broker to maintain the control of the first real estate data. A widget is insertable into a browser and the widget is programmed to provide a link to the first real estate data in response to a request for data pertaining to the first geographic region where the request is received from a broker other than the first broker. A first broker controls the first real estate data and the second broker controls the second real estate data via the dashboard. Upon linking of many broker data aggregations together a nationwide system providing a peer-to-peer network of real estate information is provided.

This application claims priority to U.S. provisional application No. 61/762,270 filed on Feb. 7, 2013.

The present invention pertains to a peer-to-peer network for the online display of information derived from aggregated real estate data, such as multiple listing services (MLSs) about real property for sale or rent to consumers who visit the publicly accessible websites of real estate brokers or agents who participate in the peer to peer network. The information to be displayed through the network is electronic listing information made available to the real estate brokers and agents (“Participants”) including those who participate in the MLS' Internet Data Exchange (IDX) program for online display to the general public on websites controlled by the Participants.

### BACKGROUND

There are many current systems available on the internet for display and sale of real estate. Current systems for the online display to consumers of real estate listing information may not allow consumers to access information about the approximately 4.3 million properties that are listed for sale with MLS Participants in the United States and contained in the IDX database compilations (“IDX Data”) of MLSs throughout the country. Furthermore, most current websites that display real estate listing information to the general public also display advertising on the web pages that present to a consumer display information about a specific listed property that may conflict with the information displayed to consumers about the same property appearing on a website owned or controlled by the MLS Participant who has listed the property for sale.

Most real estate MLSs in the United States are owned or operated by associations of REALTORS® that are member organizations of the National Association of REALTORS® (NAR). The NAR has adopted the NAR Multiple Listing Policy (“NAR MLS Policy”) that sets certain policies and rules that all MLSs operated by associations of REALTORS® in the United States must adopt and enforce among MLS Participants. The NAR MLS Policy includes certain specific provisions governing the manner in which MLSs must operate their IDX programs and the manner in which IDX Data is to be displayed to consumers on websites owned or controlled by MLS Participants. NAR MLS Policy governing the display of IDX Data requires that an MLS' IDX Data may only be displayed on publicly accessible websites, or portions of websites, that are under the actual and apparent control of brokers or agents who are MLS Participants in the MLS that is the source of the IDX Data. This limitation on the permissible display of IDX Data is a requirement of every MLS in the United States that is subject to the NAR MLS Policy. Therefore, to enable consumers to access and view online IDX information about all of the approximately 4.6 million listings contained in the IDX databases maintained by all of the MLSs in the United States that are subject to the NAR MLS Policy (or other real estate data aggregated databases), the present invention consists of tools that permit a consumer desiring to search for property for sale in multiple markets to navigate through a peer to peer network of separate websites controlled by individual MLS Participants and access IDX Data or other aggregated real estate data in each market of interest to that consumer. The actual real estate data for each market may be displayed to the consumer on a website controlled by an MLS Participant in that market in compliance with all applicable MLS Rules and Regulations.

### SUMMARY

The present invention provides for a real estate data display system comprising real estate data obtained from an aggregated source of real estate data, a repository storage area for receiving first real estate data pertaining to a first geographic region and second real estate data pertaining to a second geographic region and the first real estate data segmented from the second real estate data within the repository storage area and a first dashboard interface to enable a first broker to maintain control of the first real estate data and a second dashboard interface to enable a second broker to maintain control of the second real estate data and a widget insertable into a browser, the widget programmed to provide a link to the first real estate data in response to a request for data pertaining to the first geographic region wherein the request is received from a broker other than the first broker.

In an embodiment, the first and second real estate data may be obtained from one of an internet data exchange network (IDX) and an aggregation of broker listing data. In an embodiment, the repository storage area may comprise divisible virtual servers and the first broker controls a first virtual server containing the first real estate data and the second broker controls a second virtual server containing the second real estate data.

In an embodiment, the first and second broker may have ownership interest in the repository storage area. In an embodiment, the first real estate data and second real estate data may be contained within a server having a first segmented storage location and a second segmented storage location and the first real estate data stored in the first segmented storage location and the second real estate data stored in the second segmented storage location. In an embodiment, the first and second real estate data may be normalized so that data fields of the first real estate date is uniform to data fields of the second real estate data.

In an embodiment, the widget may be uploaded to a browser controlled by the first broker and the widget displays a drop-down menu in the browser, the drop-down menu displaying categories of geographic regions consisting of one of a state, territory, providence, city, village, town, neighborhood and subdivision. In an embodiment, the geographic regions may include: 1) state; and 2) city; only in that sequence so that a subset of the real estate listing data may be obtained from the repository storage area. In an embodiment, each geographic region of the widget provides a link to real estate data of one of a plurality of different broker controlled data contained in the repository storage area.

In an embodiment, one of the geographic regions displayed by the widget may provide a link to a second broker's website by redirecting the first broker's browser to a website controlled by the second broker, wherein the real estate data controlled by the second broker may be accessed and displayed. In an embodiment, the map may have a cluster display that is depicted on a browser and upon selection of a first cluster the browser will link to the second real estate data. In an embodiment, the cluster may be comprised of an alphanumeric symbol that represents the number of real estate properties included in the repository storage area that are geographically associated with the location of the alphanumeric symbol on the map. In an embodiment, the alphanumeric symbol may be surrounded by a geometric shape having a color that distinguishes the geometric shape from adjacent area of the map. In an embodiment, the geographic association may be a zip code.

In an embodiment, the browser may be redirected to access the second real estate data by linking to the repository storage area, a new web page is displayed including indicia associated with the second broker that controls the second real estate data. In an embodiment, the indicia may include one of a logo, broker name, broker symbol, trademark, trade name, branding, trade dress and fonts. In an embodiment, the first real estate data may include MLS listing information for properties in a selected geographic area including one of a state, territory, providence, city, village, town, neighborhood and subdivision.

In an embodiment, the dashboard provides the following control parameters: sectoring, formatting, coding, directing. In an embodiment, the dashboard may provide control parameters that allow the first broker to control the selection of an alternate broker in a preselected geographic area. In an embodiment, the dashboard may provide a customizable algorithm to be set by the first broker, the algorithm for selecting the alternate broker. In an embodiment, the dashboard may provide a default setting for selection of the alternate broker.

In an embodiment, the default setting may be for the broker having the largest number of listings in the preselected geographic area. In an embodiment, the dashboard may allow for a broker to customize a supplemental webpage on a host site that links to the repository storage area where the broker real estate data is maintained so that upon selection of the second real estate data the browser navigates from a broker website to the repository host website and via display of the supplemental webpage the second broker that controls the second real estate data has its webpage information displayed. In an embodiment, the first broker may maintain actual and apparent control over the first real estate data via the first dashboard interface and the second broker maintaining actual and apparent control over the second real estate data via the second dashboard interface. In an embodiment, the widget may be an application programming interface (API). In an embodiment, the displayed properties may be selected to obtain detailed property information and a purchasing process initiated via the system.

The present invention also provides a computer program product stored on a non-transitory computer readable medium, the computer program product having computer executable code instructions that are executable on a computer server to display real estate data, the computer executable code instructions comprising first code instructions for receiving real estate data obtained from an aggregated source of real estate data, second code instructions for receiving first real estate data pertaining to a first geographic region, third code instructions for receiving and second real estate data pertaining to a second geographic region, fourth code instructions for segmenting the first real estate data from the second real estate data within a repository storage area, fifth code instructions to enable a first broker to maintain control of the first real estate data, sixth code instructions to enable a second broker to maintain control of the second real estate data and eighth code instructions insertable into a browser, the eighth code instructions programmed to provide a link to the first real estate data in response to a request for data pertaining to the first geographic region wherein the request is received from a broker other than the first broker.

In an embodiment, the eighth code instructions may provide a drop-down menu on the first broker webpage to display a state and then to display a city and upon selection of a city, ninth code instructions link to a website of the second broker and display the second real estate data.

### BRIEF DESCRIPTION OF THE DRAWINGS

FIG. 1 is a flow diagram of the present invention;

FIG. 2a is a screenshot of a first broker's webpage;

FIG. 2b is a screenshot of the first broker's webpage including a drop down menu;

FIG. 3a is a screenshot of a first broker's webpage depicting available peer cities;

FIG. 3b is a screenshot a first broker's website displaying available peer cities and zip codes;

FIG. 3c is a screenshot depicting a second broker's webpage;

FIG. 3d is a screenshot of a second broker's webpage showing additional information;

FIG. 3e is a screenshot of a third broker's webpage;

FIG. 4 is a screenshot of a first broker's webpage depicting clusters;

FIG. 5 is a screenshot of a Dashboard;

FIG. 6a is a screenshot of a Data Feed;

FIG. 6b is a screenshot of a Fata Feed with additional information;

FIG. 6c is a screenshot of a Data Feed with additional real estate information;

FIG. 7 is a screenshot of the Branding webpage;

FIG. 8 is a screenshot of the Company Information webpage;

FIG. 9 is a screenshot of the Install Widgets webpage;

FIG. 10 is a screenshot of the Peer Selection webpage; and

FIG. 11 is a schematic view of the hardware of the present invention.

While the invention is amendable to various modifications and alternate forms, specific embodiments have been shown by way of example in the drawings and will be described in detail, it should be understood that the intention is not to limit the invention to the particular embodiments described. The intention is to cover all modifications, equivalents and alternatives falling within the spirit and the scope of the invention.

### DETAILED DESCRIPTION

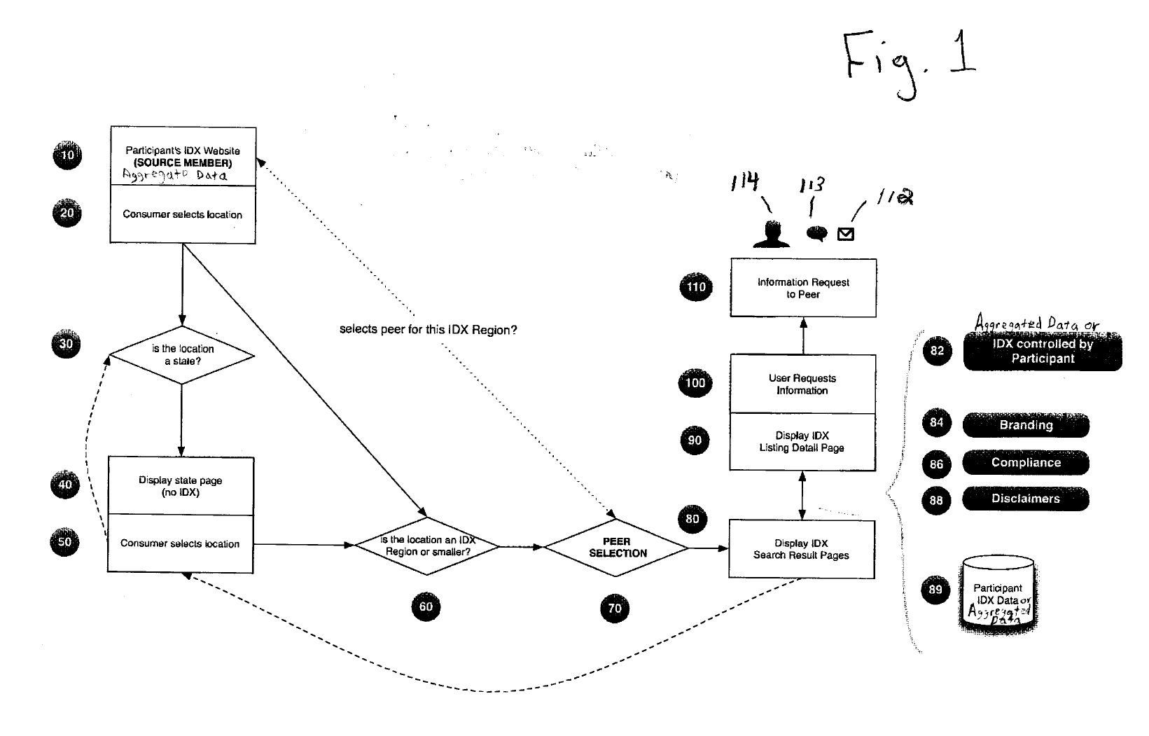

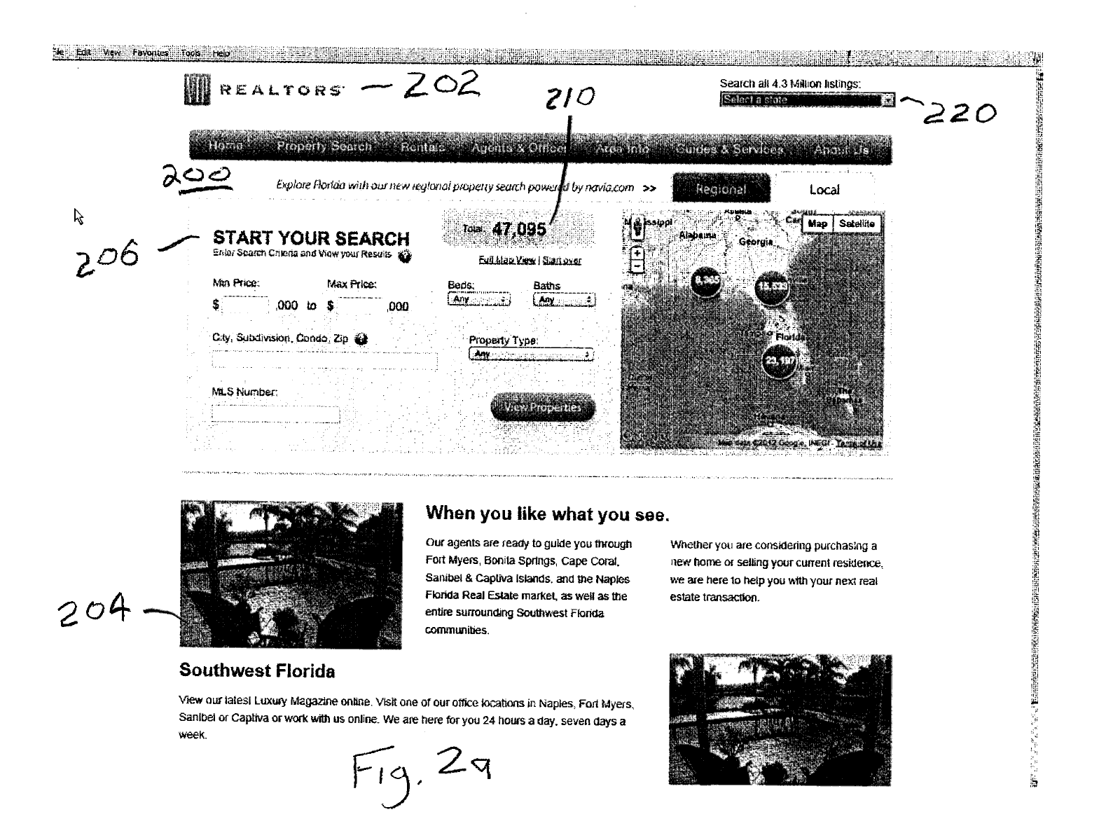

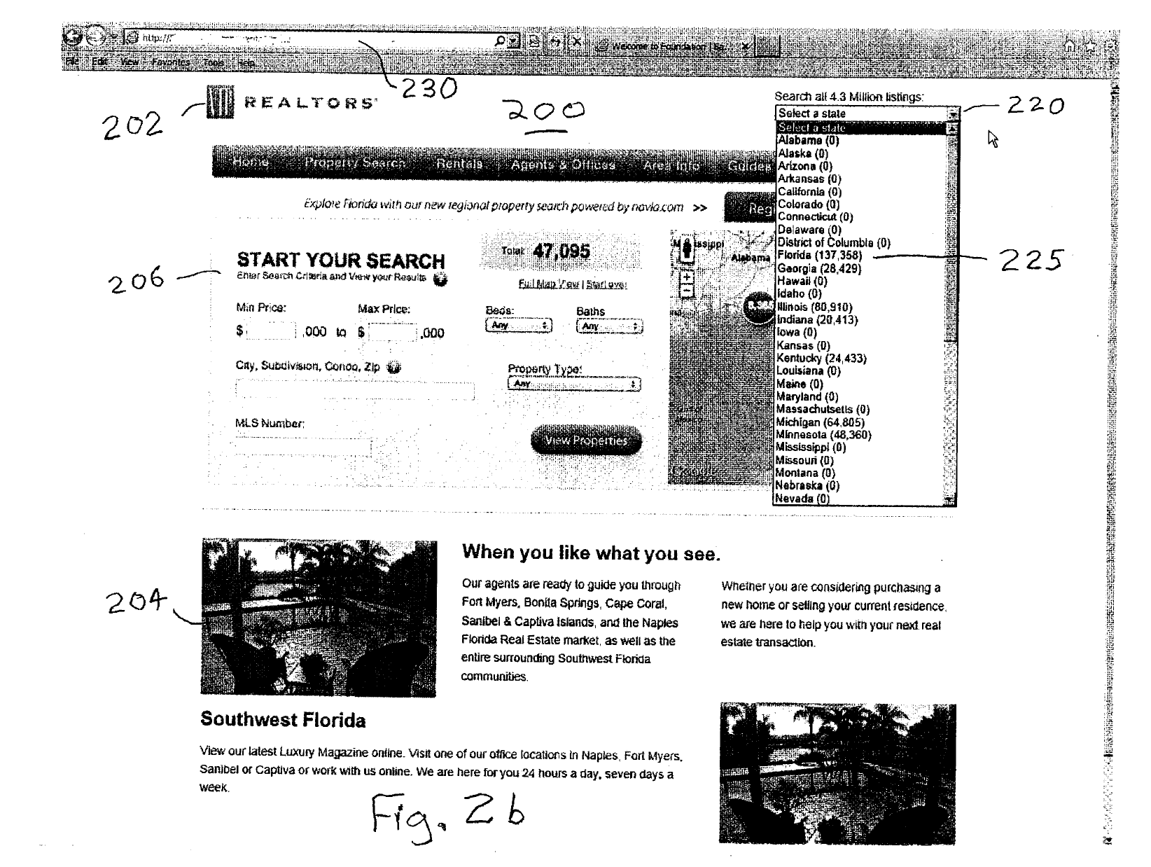

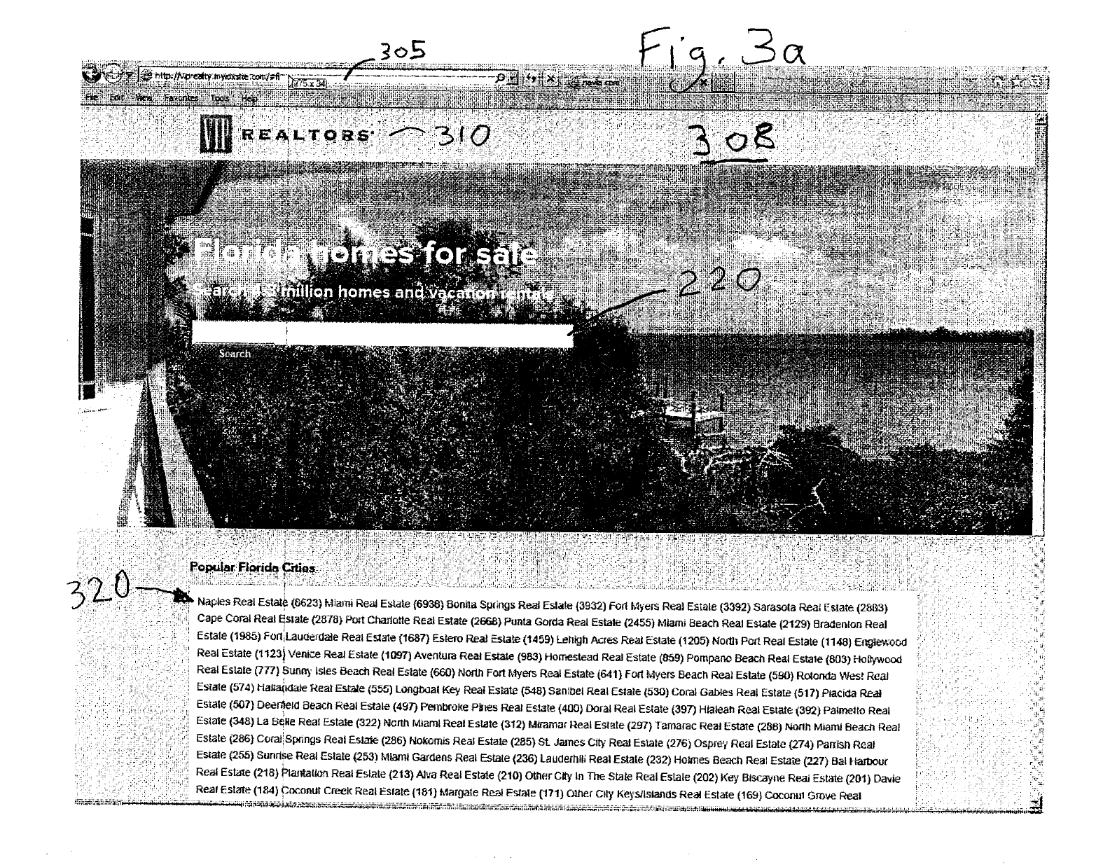

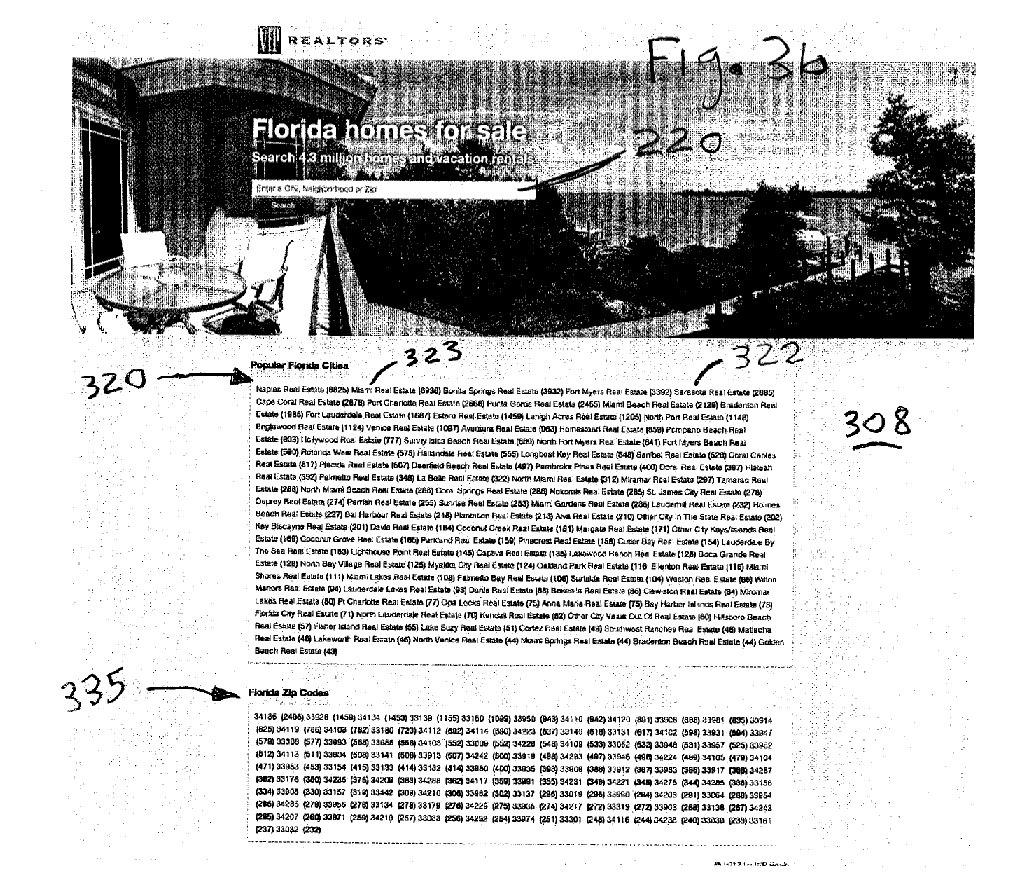

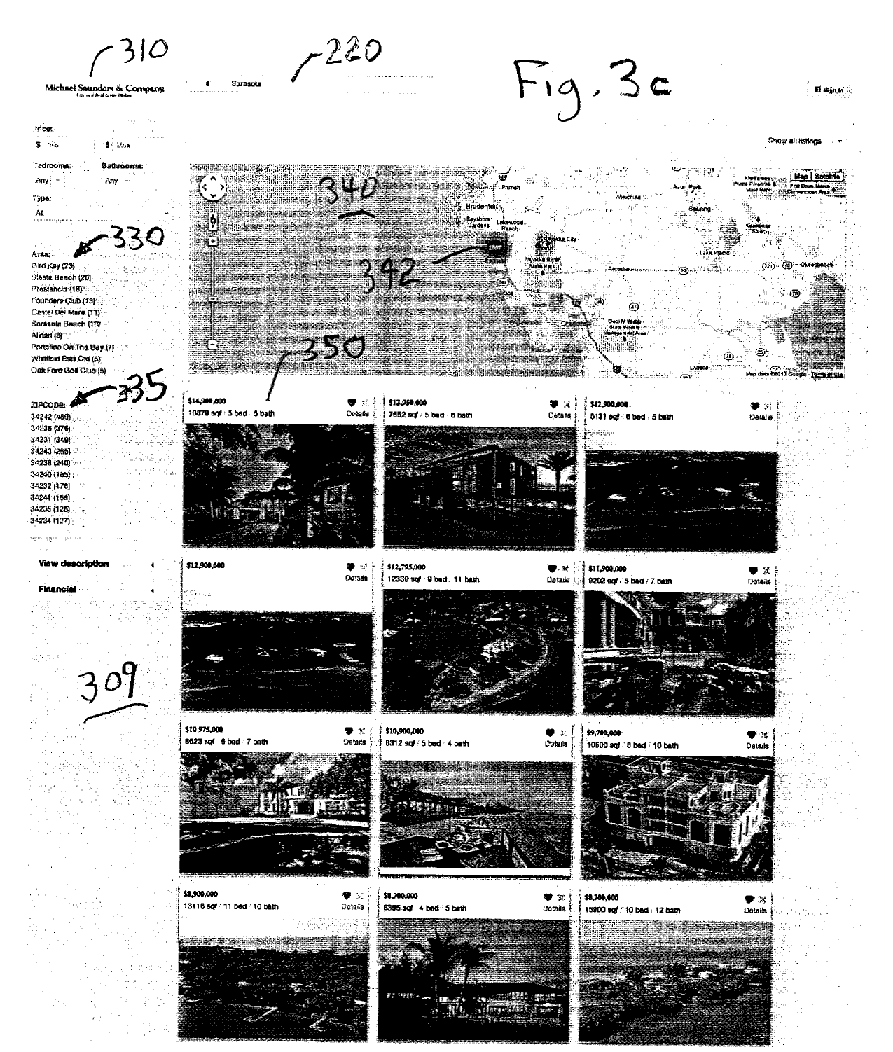

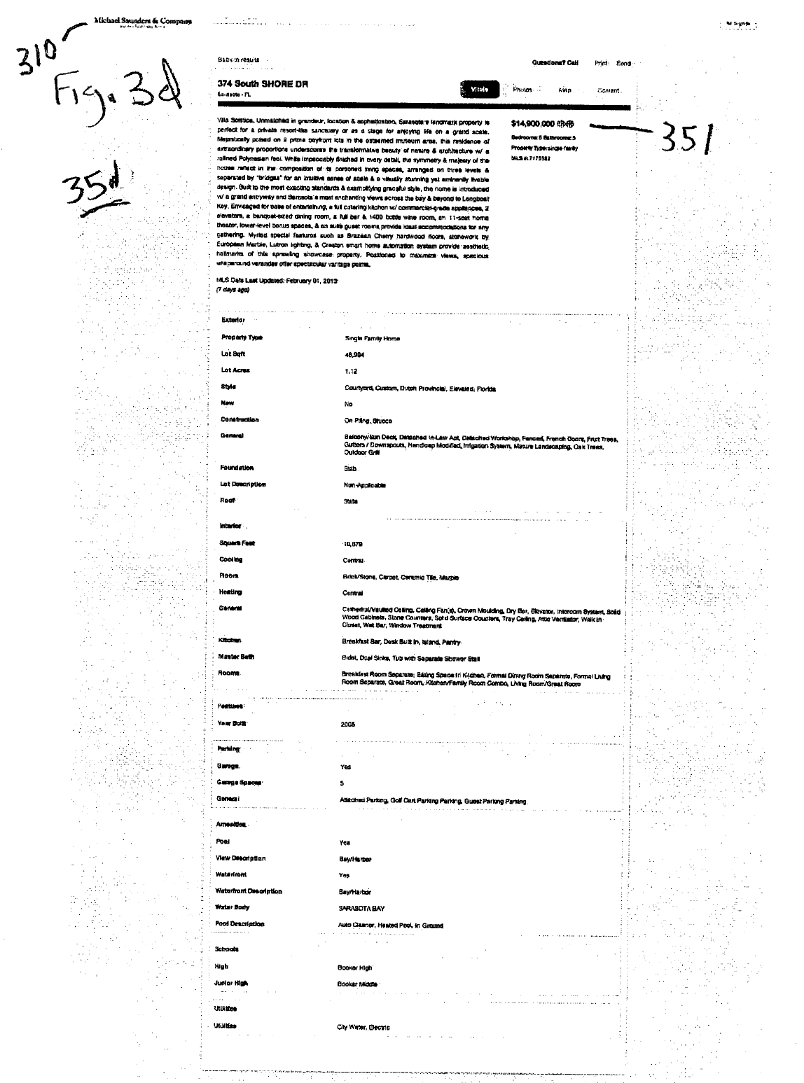

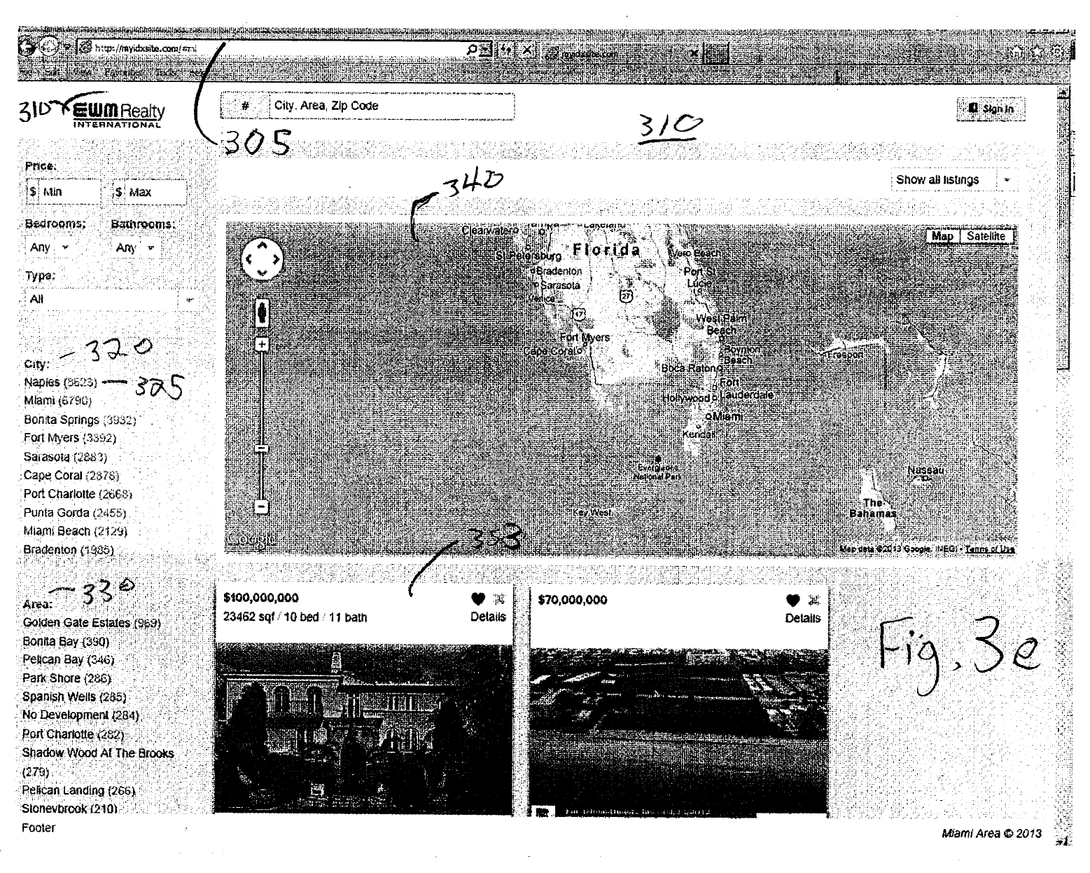

The present invention is described with respect to FIGS. 1-10, which describe a particular embodiment of a real estate data display system and a peer-to-peer network. Turning to FIG. 1, a flow diagram of the usage of the peer-to-peer network system is described with respect to steps 10 through 110. An embodiment of the invention will be described with respect to FIG. 1 and also as an example the screen shots of FIGS. 2a, 2b and 3 will be used to illustrate the invention. At step 10 on FIG. 1 the MLS Participant sets up an IDX web site or uses their current IDX web site. As discussed further below, upon receipt of search query from a consumer, the search engine operating on the MLS Participant's IDX website will access the relevant IDX Data from the MLS in which the MLS Participant participates from a database repository of IDX Data from all of the MLSs in which the peer to peer network members are MLS Participants.

In an alternative embodiment, the data may be obtained from an aggregation of broker listing data. Each peer to peer network member will have actual and apparent control over a server that contains the real estate data or the sector of the database repository storage area that contains the IDX Data from the MLS in which the network member is an MLS Participant as required by the NAR MLS Policy. The IDX Data from all of the MLSs in which the peer to peer network members are MLS Participants is stored on a single IDX Data repository server 89 (FIG. 1).

In an embodiment, the data may be stored in a first virtual server for a first broker's information and a second (separate) virtual server for a second broker's information. The IDX Data from all of the MLSs is normalized and de-duplicated by a third party service provider (TSP) to provide a “clean” data base, free of duplicate property listings. The IDX Data in the repository server will include IDX Data from all of the MLSs in which the peer to peer network members are MLS Participants. When sufficient members are participating in the peer to peer network and contributing IDX Data from their MLS to the IDX Data repository, and a TSP normalizes the IDX Data, the IDX repository server will contain combined IDX Data about the approximately 4.3 million properties listed with MLS Participants in the United States that are currently in in the separate IDX database compilations operated by the individual MLSs throughout the United States that are subject to the NAR MLS Policy.

Each peer to peer network member will control the IDX Data in the combined IDX Data repository that originates from the MLS in which the peer to peer network member is an MLS Participant. The search engine technology used on the IDX websites of the peer to peer network members will enable consumers to navigate from the IDX website of one peer to peer network member to the IDX websites of other peer to peer network members and, as a result, the consumer may access through the peer to peer network IDX Data about the approximately 4.6 million properties listed with MLS Participants throughout the United States.

As shown in FIG. 2a, a sample web page 200 of VIP Realtors is depicted. This is a fairly standard web page that includes the VIP Realtors logo 202 on the upper left, a display of photographs of highlighted properties 204 and, in this instance a local search bar 206. On this web site a localized search is available via the local search bar 206 for western Florida area that includes 47,095 MLS listings, as shown in the search bar 210. The localized search bar 206 may be omitted once the MLS Participant joins the peer-to-peer network because access to real estate property information from across the United States including western Florida would be available. In an alternate embodiment, the MLS Participant may maintain the localized search bar 206 while engaging in a national search through the peer-to-peer network.

As will be discussed in more detail below, the MLS Participant can quickly and easily join the peer-to-peer network and quickly update its web site 200. After joining the peer-to-peer network and providing certain information, a API widget or application is uploaded to the MLS Participant's individual IDX web site in order to insert a drop-down menu 220 in the upper right-hand corner of the web page 200. In an embodiment, the drop-down menu 220 will state, “Search all 4.3 Million listings:” and in the top of the drop-down menu the words “Select a state” will appear.

According to FIG. 1 at step 20, the consumer selects a geographic location where he/she desires to search for property. As illustrated in FIG. 2b, by clicking on the arrow in the drop-down menu 220, a list of all 50 states will be exposed (step 30, FIG. 1). As can be seen in the drop-down menu, each state is listed and to the right of the state is provided a total number of property listings 225. For example, under the heading for Florida there are 137,358 property listings. Although many of the states listed in the drop-down menu depicted in FIG. 2b show “(0)”, as the system becomes more popular and more MLS Participants join the peer-to-peer network, IDX Data from each of those states will be included in the network, as will be discussed in more detail below. For example the current drop-down menu 220 indicates that there are no network members or “peers” for the states of Alabama, Alaska, Arizona, Arkansas, California, Colorado, Connecticut, Delaware, District of Columbia, Hawaii, Idaho, Iowa, Kansas, Louisiana, Maine, Maryland, Massachusetts, Mississippi, Missouri, Montana, Nebraska, Nevada. As MLS Participants join the peer to peer network from those states they will authorize and deposit IDX Data from their respective MLSs in the IDX repository server data base 89 (FIG. 1) and consumers visiting an IDX website of one peer to peer network member may then use the network search engine technology to access the IDX Data displayed on the IDX sites of every other peer to peer network member, and eventually will have access through the peer to peer network to all IDX Data from all MLSs in the United States, assuming sufficient numbers of MLS Participants join the peer to peer network.

The user can select the desired state by clicking on the state from the drop-down menu 220 (step 40, FIG. 1). For example, if the user clicks on the Florida button 225, the browser will redirect to a peer site preselected by VIP Realtors in Florida. For example, as shown in the IP address box 230 in FIG. 2b, viprealty.com is the web site for VIP Realtors (first broker). The webpage 308 includes a city search area 320 according to Popular Florida Cities and a zip code search area 335 according to Florida Zip Codes. A user may click on a specific city or zip code in either search area 320, 335 in order to move forward with a property search (step 60, FIG. 1). It is noted that the webpage 308 also includes a search bar 220, so that a user may type in by hand the city or zip code for the desired property search.

Following selection of a city from webpage 308, for example Sarasota 322 the browser will redirect to a peer website 309 that has contributed its Sarasota MLS listings to the IDX repository server as shown in FIG. 3c (step 70, FIG. 1). In this example, the logo area 310 indicates that Michael Saunders & Company is the peer brokerage firm (second broker) that is the member of the peer to peer network system. This webpage allows for more detailed searching within the Sarasota area by selecting a specific photo of a property 350, or by using the area search box/area 330 or the zip code search box/area 335 (step 80, FIG. 1). A map 340 is also displayed that includes a cluster indicia (circle) 342 to identify the number of listings available in the Sarasota area at 2,887.

Once a user makes a further selection, for example selecting the property displayed in photograph 350, the IDX repository server will query the IDX repository data base 89 and locate the requested IDX listing. The browser will then navigate to webpage 351 as shown in FIG. 3d that displays the detailed information for the selected property (step 90, FIG. 1). For example, the sale price of $14,900,000 is listed at the top right area 351 and matches the sale price listed on webpage 309 identified with photograph 350. At that time the user may request to be contacted by e-mail 112, text 113 or phone call 114 (steps 100, 110, FIG. 1) regarding purchase or investigation regarding that property 350. As discussed previously, the peer to peer network member who contributed the MLS listing data to the IDX repository server maintains control over the IDX Data from the MLS in which that peer to peer network member is an MLS Participant, and also continues to have a presence on the webpage 351 by display of its logo in area 310.

By way of further example, a search for Naples, Fla. properties will be explained. Returning to FIG. 2b, once the user clicks on the Florida button 225 from the drop-down menu 220, it will be redirected to the IDX repository server as shown in FIG. 3a, b. IP address box 305 shows the URL of viprealty.myidxsite.com, a web page that is supported by the MLS listings for Florida. In this example by clicking on the Florida button from the initial participant's webpage 200, the user is able to query the IDX repository data base via the server 89 from the VIP Realtor webpage 308 (FIG. 3a,b). FIG. 3a is an enlarged view of the webpage 308 including IP address bar 305 and FIG. 3b is a full view of the webpage showing the full search capabilities. As shown in the IP address bar 305 it can be seen that the URL includes myidxsite.com that indicates the browser has linked to the IDX repository server. Nevertheless, the user continues to see the VIP Realtors logo 310. In an alternative embodiment, the URL will be modified from VIPRealty.MyIDXSite.com to a random alpha numeric address.

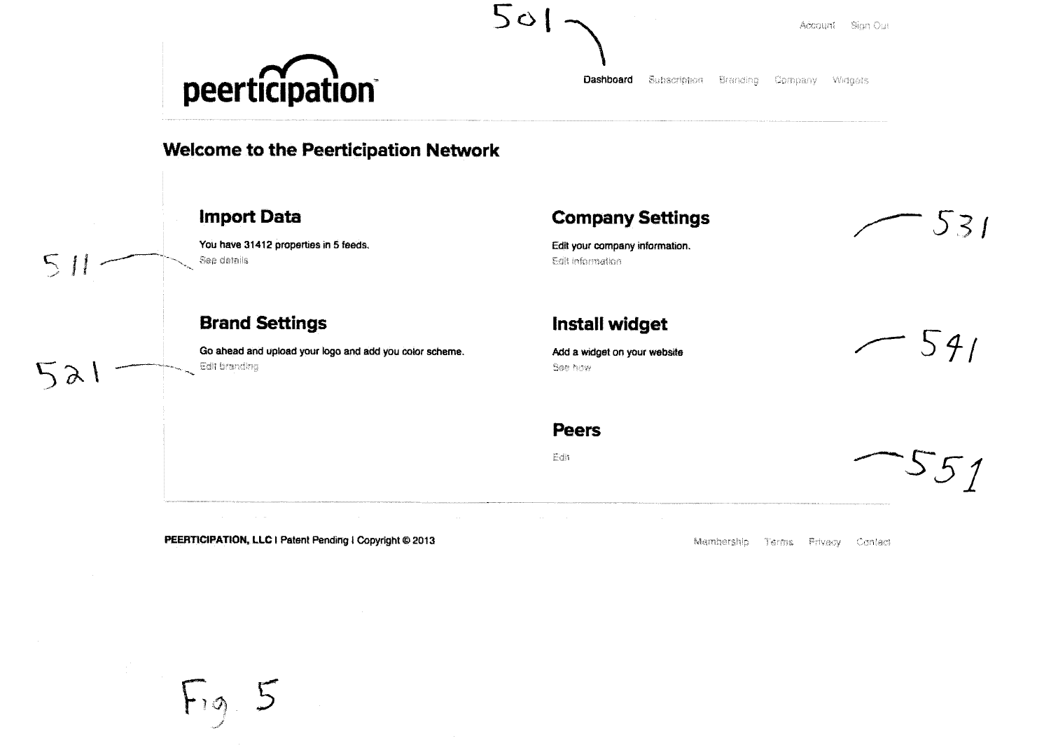

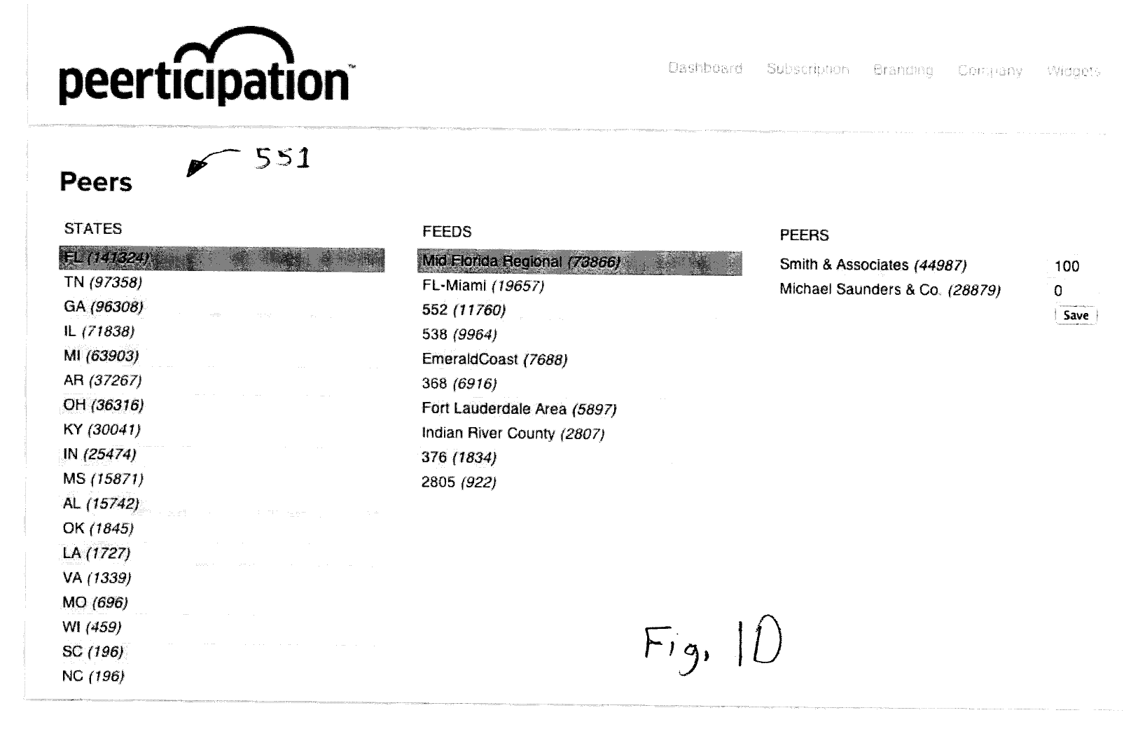

From webpage 308 the user selects the Miami Area link 323 and the browser will navigate according to instruction from the IDX repository server to a peer website 310 as depicted in FIG. 3e. The MLS listings for the Miami Area have been deposited in the IDX repository data base server 89 by EWM Realty International, as evident by its logo 310. Since EWM Realty International is the participant in Florida that VIP Realtors had selected to be its peer (see Dashboard discussion regarding FIG. 5 and FIG. 10), the EWM listings will be displayed for the users traveling from the VIP web site 200 (when searching in Florida).

As shown in FIG. 1, after steps 10 and 20, the dashed line shows that a peer was selected for this IDX region and the process skipped ahead to box 70 for peer selection. Step 80 occurs where the user can continue the search and display search result pages from the IDX repository data base 89. Steps 30-60 from FIG. 1 explain how the user may narrow its search down from a state to a smaller area such as a city. At step 30 the user may choose a location by the state. For example, the web page 310 of FIG. 3 can be displayed when a user selects Florida. The consumer then selects a more granular location at step 40 and 50 by seeking a region or a smaller location such as a city via the IDX repository server data base at step 60.

For example, as shown on the web page 310 in FIG. 3e, a listing of cities is provided in city search area 320, including: Naples, Miami, Bonita Springs, Fort Myers, Sarasota, Cape Coral, Port Charlotte, Punta Gorda, Miami Beach and Bradenton. Below that is Area search bar/area 330 which allows the user to select not by individual cities but by larger geographic portions, such as: Golden Gate Estates, Bonita Bay, Pelican Bay, Park Shore, Spanish Wells, No Development, Port Charlotte, Shadow Wood At the Brooks, Pelican Landing and Stoneybrook. As described above, each city or area listed in the portions of the web site 320 or 330 include parentheses to the right of the geographic location which identify the number of MLS listings available in that location. For example, Naples button 325 indicates that there are 8,623 MLS listings available for the user to search in that location. This indicates that the peer-to-peer network includes brokerage firms that have deposited 8,623 listings in the IDX repository data base.

Just as web page 310 designated EWM Realty International as indicated by the logo in the upper left-hand corner 310, each of the further web sites will also designate specific broker firms on each web page. Each web page provides clear identification of the name of the brokerage firm that controls the particular data from the selected geographic region. As discussed further below, each brokerage firm controls the deposit of the IDX Data from its MLS to the IDX repository data base and controls what data is on the web page—thus, maintaining compliance with the NAR MLS Policy.

The typical web page 310 includes a map 340 (FIG. 3). In an embodiment, the map may be used by clicking on areas which will identify clusters of listing in the IDX database compilation. Such clusters may be further segregated and the number of IDX listing located in each cluster (or circle) on the map will be reduced each time the user clicks for a closer view of a specific area in order to show an enlarged view of the geographic location. The web page 310 also includes featured properties using photos, for example 350. Further details of those properties may be found by clicking on the detail tab, at which time the specific brokerage firm that is representing the owner of that property will appear in the listing with the other normal detailed information about the property.

Turning back to FIG. 1, step 80 is accomplished by displaying specific IDX search results and at step 90 the detailed listing page is displayed. By clicking on the photograph 353, as shown in FIG. 3e, the user requests MLS information according to step 100 in FIG. 1. The property information is then sent to a peer participant who is the registered agent for the property depicted in photo 350 in FIG. 3. Step 110 in FIG. 1 is accomplished through the display of the MLS property information. At that time the user may request to be contacted by e-mail 112, text 113 or phone call 114 (FIG. 1) regarding purchase or investigation regarding that property 353.

As mentioned above, the IDX display information is controlled by the peer network member from whom the original user originated his or her search and is described with respect to items 82-89 in FIG. 1. Item 82 confirms that the IDX Data is controlled by the peer to peer network member MLS Participant via selection of specific data when the participant joins the peer-to-peer network. Further at step 84, the participant controls the branding such as the logo 310 (FIGS. 3a-e) or logo 202 (FIG. 2a) that appeared on the web pages 310, 200, respectively for example. At step 86 the peer to peer network member is responsible for maintaining compliance with the their MLS' IDX Rules and Regulations by maintaining control of the IDX Data originating from the MLS in which the network member is an MLS Participant, as will be discussed in more detail below. At step 88 the peer to peer network member may also include disclaimers on their IDX website that are applicable to users of the website. Step 89 indicates the IDX Data from the MLS in which the peer to peer network is a Participant is maintained in the IDX Data repository data base, which is accessed according to the instructions provided by the MLS Participant when joining the peer-to-peer network.

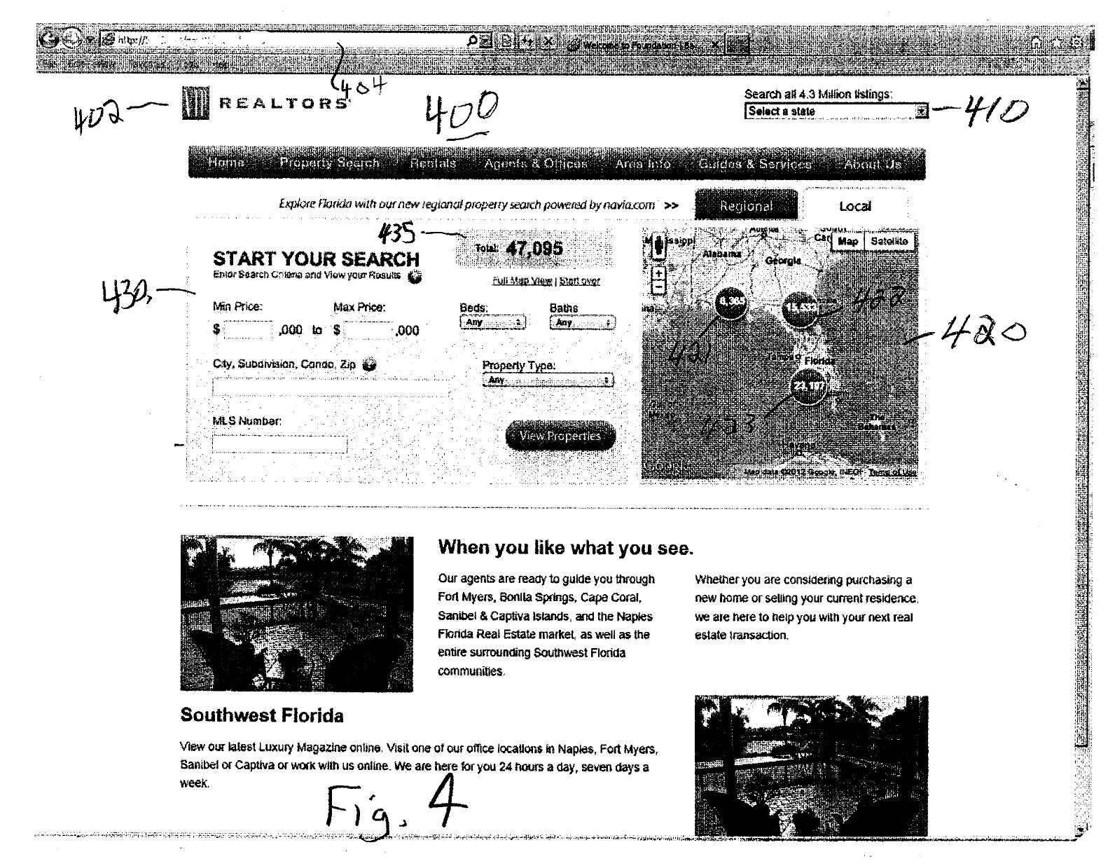

Turning to FIG. 4, another example of a peer to peer network member's IDX web page 400, is depicted. This web page is for VIP Realtors, as designated by its logo 402 and its URL provided in the IP address box 404. Once VIP Realtors joins the peer-to-peer network visitors to VIP Realtors IDX website may link to the IDX Data displayed on IDX sites of other peer to peer network members from around the United States by inserting the drop-down menu 410. As discussed above, the peer to peer network member who is displaying the individual information may provide a map on the member's site that shows cluster indicia (circles). For example, in FIG. 4, three clusters are shown on the displayed map 420. Cluster one is located in the panhandle of Florida 421. Cluster one indicates that there are 8,365 MLS listing properties in that location. Once the user were to click on that circle identifying cluster one (421), the map expands that area, and the single cluster will be broken out into multiple clusters identifying the locations of those properties contained in the IDX database.

Map 420 also includes a second cluster 422 located generally in the Jacksonville area. The circle on the map for cluster two (422) indicates that there are 15,533 IDX listings in the Jacksonville area. Map 420 also shows a third cluster 423 which indicates that there are 23,197 IDX listed properties in the Naples area. These properties are contained in the IDX Data controlled by VIP Realtors and as a member of the peer-to-peer network these properties are available to the other peers in the network who wish to link to VIP Realtors information made available through the IDX URL.

For example, because VIP Realtors (discussed with respect to FIG. 2a, b) includes properties in Western Florida, the customers of VIP Realtors will have access to those Western Florida listings. When a user goes to the VIP Realtors web site and clicks on the drop-down menu 410 and selects Western Florida, it will be directed to the VIP Realtors IDX listings from the IDX repository data base. When a user of the VIP Realtors web site 400 merely wishes to search properties in the Florida area that are VIP Realtors IDX listings, it can use the search box 430. The user will not need to undertake a national search and use the drop-down menu 410. It is understood that the search bar 430 n the VIP Realtors page 400 includes only a total of 47,095 MLS listings as shown in box 435. Since there are no listings of other brokerage firms, the searching available for the box 430 are only those listings of VIP Realtors. Should the user want to have the option of selecting other properties in Florida beyond the 47,095 available through VIP Realtors, it would go to the drop-down menu 410 and select the Florida tab. The user would have the choice of searching from 137,358 IDX listings provided by the IDX repository data base as shown at position 225 on the drop-down menu in FIG. 2b. That same drop-down menu would appear in FIG. 4 when the box 410 is selected.

The process of becoming a member of the peer-to-peer network will now be discussed with respect to FIGS. 5a-10 (screen shots). The potential member or broker will navigate to the peer-to-peer web page dash board, for example peerticipations.com. The dashboard (FIG. 5) is used by a member to specify how its IDX Data is to be imported 511, its brand settings 521, company settings 537, installing the widget 541 and selecting peers 551. The dashboard 501 is used and so that the member maintains control over its real estate data and so that the public will associate the particular contributed IDX Data with that member/broker by inserting the member's name or logo on the pertinent webpages.

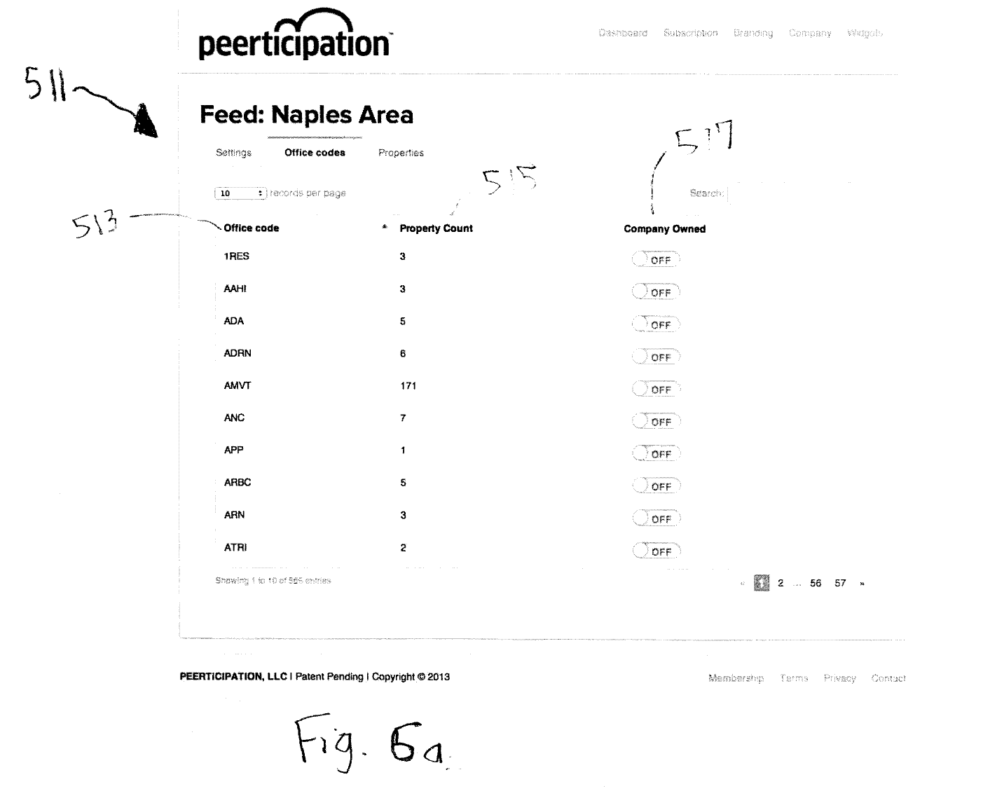

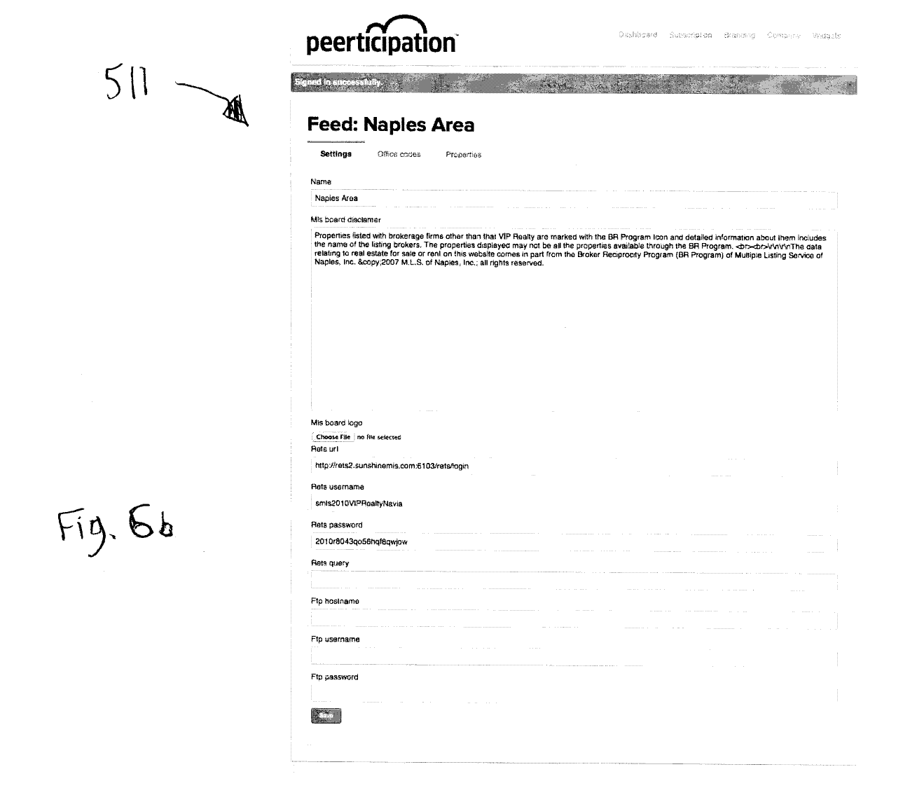

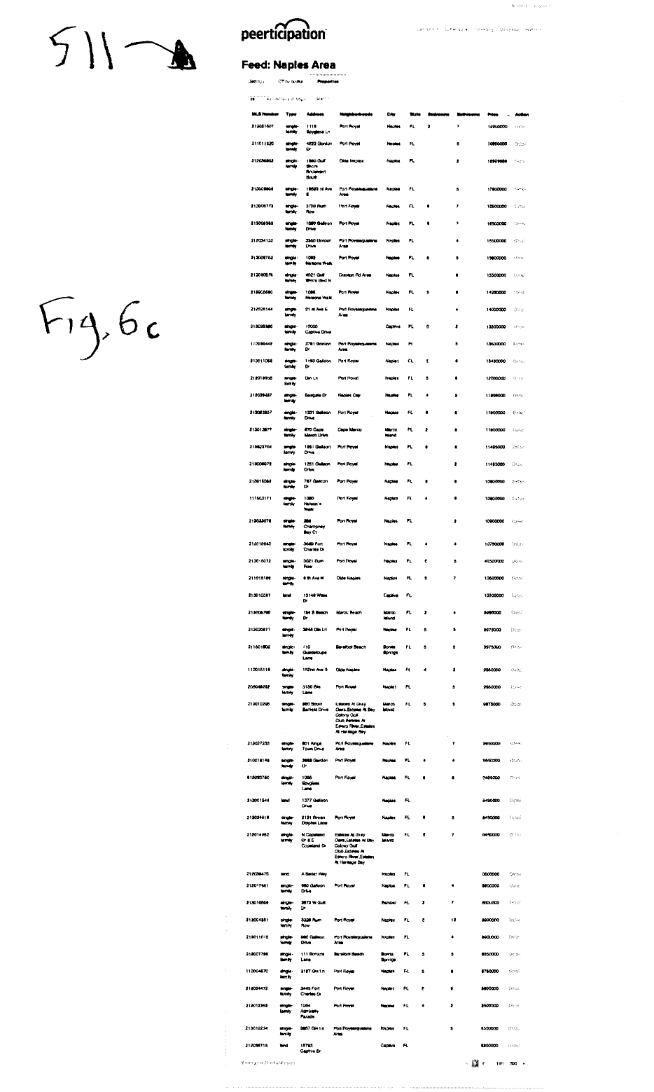

Turning to FIGS. 6a-c, the member/broker will designate how data is fed to the data repository. As shown in FIG. 6a each group of properties designated by an office code 513 and Property Count 515. For each of properties 513 the member may use an “ON” “OFF” toggle switch to identify those properties that are Company Owned 517. In the example presented by screen shot 511, the properties are from Naples, Fla. Turning to FIG. 6b, the member may designate the data feed by providing “settings” including property name e.g. “Naples” providing MLS Board disclaimer, MLS Board logo, RET URL, RETS USERNAME, RETS passwords, RETS query, FTP hostname, FTP username and FTP password. FIG. 6c depicts the “properties” listing of the data feed by MLS number, type e.g. single family or land, address, city, state, number of bedrooms, number of bathrooms, price and action e.g. “sold.”

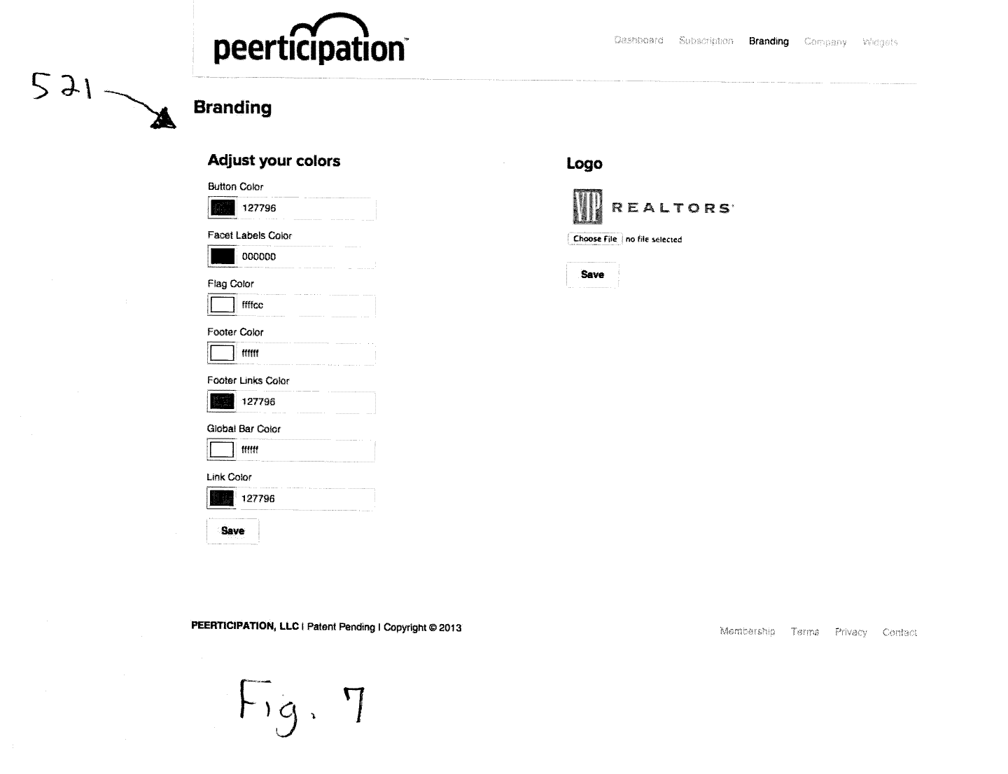

Turning to FIG. 7, the member may modify the particular items to appear on their peer/supplemental web site by adjusting colors for the facet, flag, footer, global bar and link. The member may insert artwork for its logo and will save this information to the peer-to-peer web site. In the next step, as shown in FIG. 7a, the member can identify the MLSs in which the member is an MLS Participant. The member will save the information to the peer-to-peer network in order to control the IDX repository server according to such instructions.

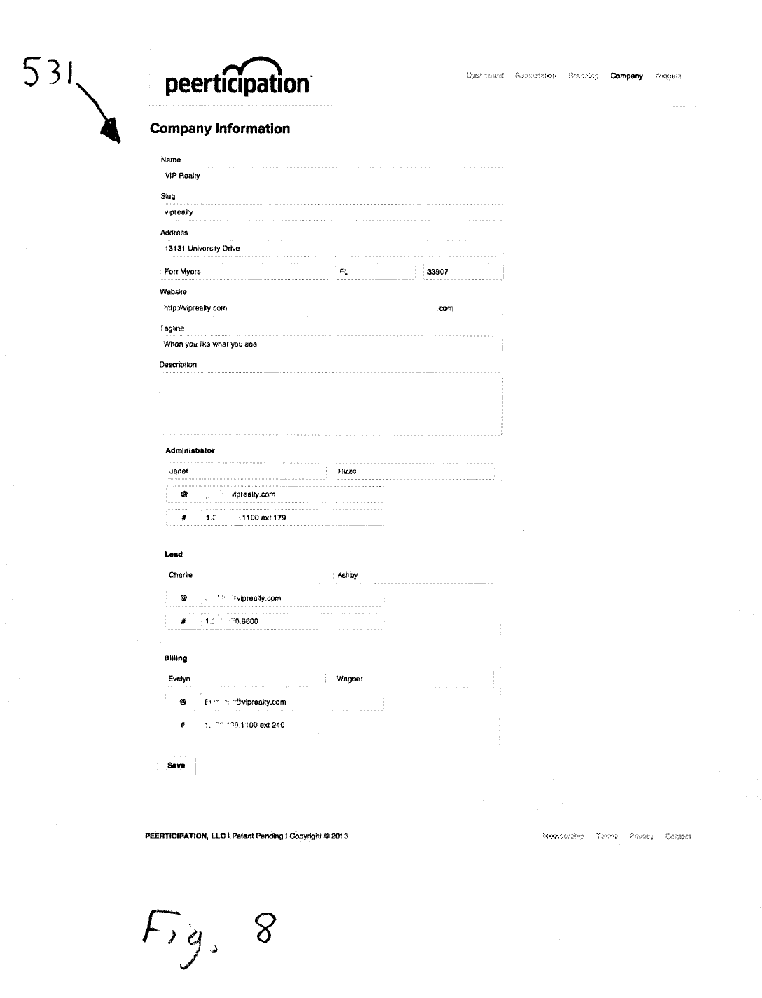

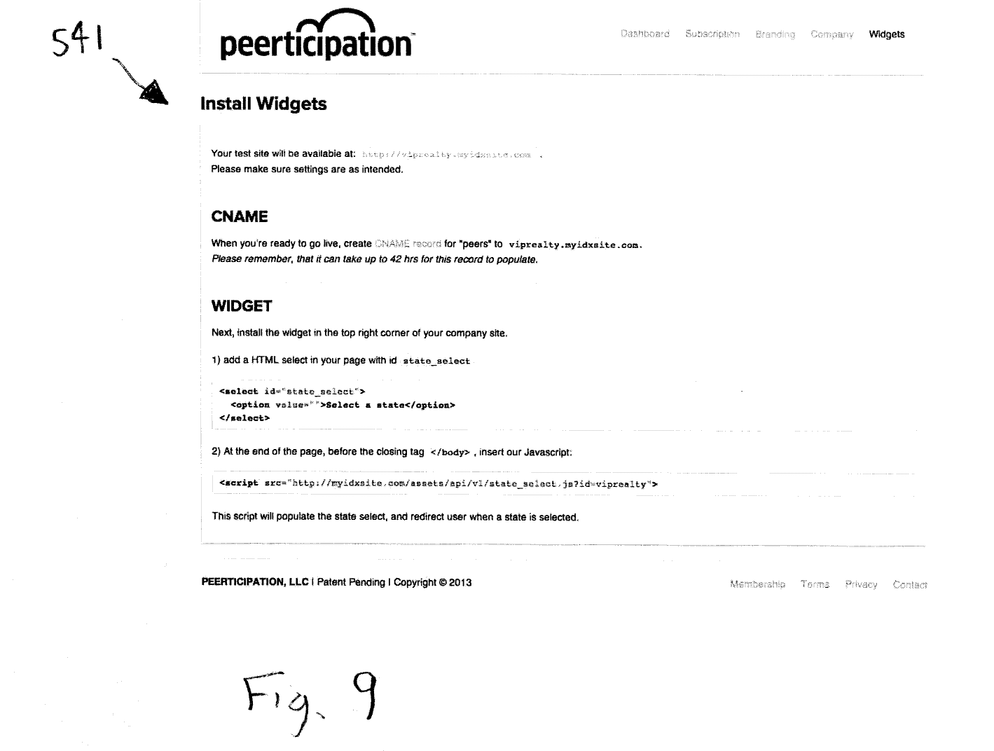

At FIG. 8 web page 531, the member will register by putting in the company name, slug, address, any optional URL address or tagline, the administrator's name, lead billing name information. The member will then save that information. FIG. 9 depicts the Install Widgets web page 541 and provides a URL for a test site a CNAME record and provides the HTML code and JavaScript to insert in the web page. In FIG. 10, the member will use this web page 551 to provide peer settings in particular areas. The member, for example in Florida, can set a default setting by which the peer-to-peer network will identify the brokerage firm that has the most listings in that area. When a user activates a button/tab in the drop-down menu 410, 220, (FIG. 3c, 4) as discussed above, the IDX repository server will default to the peer to peer network member firm having the most listings in those areas when the user selects that specific location. In the alternative, in Florida, Mid Florida Regional, the member may select Smith & Associates as its peer (second broker) in that area. Likewise, other selections are provided in other areas around the country, or default selections may be made by the member by clicking on those items as shown in FIG. 10. FIG. 10 continues the list of other areas around the country where a default or specific brokerage firm may be selected. As shown in FIG. 10, the member clicks on the Save button in order to save its preferences for the control of the linking that will occur by its users.

Turning to FIG. 9, the final setup of the member's web site is made available by allowing the member to test their site by going through a special IDX web site, where the member can make sure that the settings are all set properly. When the member is ready to go live with its site, it can create a CNAME record for their peers and then within 42 hours the records will populate for those peers and the system may be used by the visitors to the member's IDX website. The final step is for the member to install the widget/application by clicking on the code space on the web page shown in FIG. 9.

Therefore, it may be understood that the present system provides for a quick and easy set-up by a member (first broker) in the peer-to-peer network, that allows for the member to retain control of the IDX Data from the MLS in which the member is an MLS Participant by depositing the IDX Data into the IDX repository server data base according to the controls provided in the setup procedures as discussed above for FIGS. 5a-10. According to such set-up configurations, the users of the member's IDX web site continue to see the logo of the originally visited web site.

It is to be understood that when a user clicks on the browsers “back” button, he/she will continue to maintain his links back to the original IDX website of the peer to peer member at which he started his search. For example, as discussed above, the VIP Realtors site was the initial site visited (first broker). Should the user go to VIP's peer site of VIP Realtors (second broker) on web page 400 (FIG. 4) once the user clicks on the back button from web page 400 he or she will be returned to the VIP Realtors web site 200 (FIG. 2b) (even if the user had visited other peer to peer sites linked from the VIP Realtors web page 400 (FIG. 4)).

In an embodiment, the IDX Data from each peer is aggregated by a third party vendor in order to provide uniformity of the data, so that it can be quickly and easily searched such as via an SQL data base connected to the IDX repository server. The third party service provider will normalize and de-duplicate the data in order to avoid any overlapping or duplication of IDX listings. In this way the searching on the peer-to-peer network will retrieve IDX Data of great quality and provide for high satisfaction of users.

The invention may be implemented using conventional channel all-purpose computers programmed according to the teachings of the present invention as will be apparent to those skilled in the computer art. Appropriate software can be readily prepared by programmers of ordinary skill in the art based on the teachings of the present disclosure. An appropriate computer system may include a bus or other communication mechanism for communicating information and a processor coupled to a bus for processing the information. The computer system may include a main memory, such as a random access memory (RAM) or other dynamic storage device, coupled to the bus for storing information and instructions to be executed by a processor. The computer system may include a read only memory (ROM) or other static storage device coupled to the bus for storing static information and instructions to the processor. A storage device such as a magnetic disk drive or optical disk may be provided and coupled to the bus.

The computer system may be coupled via a bus to a display, for displaying information to a computer user such as a company or brokerage firm using the peer-to-peer system. The mapping of inputs may reside in a computer readable medium. The term computer readable medium is used here and refers to any medium or media that participate in providing instructions to a processor for execution. Such a medium may take many forms, including but not limited to, volatile media, nonvolatile media and transmission media. Volatile media includes dynamic memory, such as main memory, nonvolatile media includes, for example, optical and magnetic disks, such as a storage device. Transmission media includes coaxial cables, copper wire and fiber optics, including the wires that comprise a bus. Transmission media can also take the form of acoustic or light waves, such as those generated during radio wave and infrared data communications.

Common forms of computer readable media include, for example, a floppy disk, a hard disk, flexible disk, magnetic tape or any other magnetic medium, a CD, a CD ROM, any other optical medium, punch cards, a RAM, a PROM, a FLASH EPROM, and EPROM, any other memory chip or cartridge, a carrier wave, or other medium form a computer can read.

Varying forms of the computer readable medium may be involved in carrying sequences of one or more instructions to the processor for execution. The computer system may include a communications interface to the bus. The communication interface provides a two-way data communication coupling to a network such as any packet switch local area network (LAN) or an asymmetrical digital subscriber line (ADSL) card, an integrated services digital network (ISDN) card or modem to provide a data communications connection to a telephone line.

The network typically provides data communication to one or more networks through other data devices such as via IP (internet protocol) network (e.g., the internet) that transmits notifications and receives data including program code through the networks.

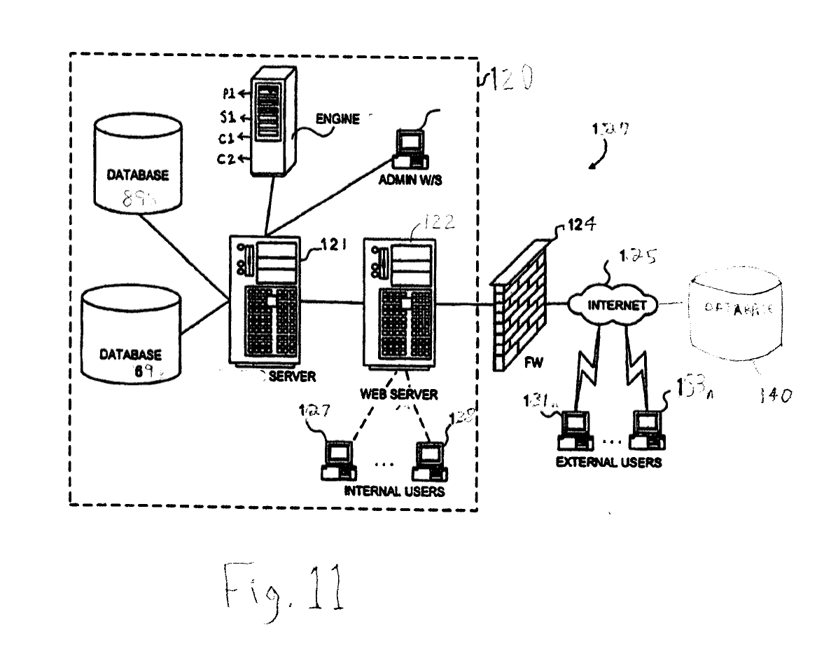

In an embodiment, the peer-to-peer network system 120 (FIG. 11) includes an exchange platform including a server 121, that serves as a “back end” (i.e., IP processing system of the present invention). Connected to the server is a data base 89a,b. The server 121 is connected to a web server 122 which sends out web pages in response to hypertext transfer protocols (HTTP) (or hypertext transfer protocol secured (HTTPS) requests from remote browsers. The web server provides a “front end” for the exchange system via graphical user interface (GUI) to users of the system in the form of web pages of real estate brokers that have, for example, real estate information via a plurality of work stations 131n, 133n and administrative work stations. These systems are supported by computer servers and software for providing the processing of requests for real estate data. The internet 125 of the outside LAN 127 may include a plurality of external work stations to access the IDX repository server data base 140. The system may be run in a distributed fashion over a plurality of network elements connecting via LAN. Data bases physically located on one or more computers may or may not be integrated in the same servers.

Communication between parties using the peer-to-peer system may be accomplished through any suitable communication means, such as telephone network, internet, intranet, point-of-sale device, personal digital assistant, cellular phone, kiosk, online communications, wireless communications, offline communications, transponder communications, etc. For security reasons any data bases, systems or components of the present invention may consist of any combination of data bases or components at a single location or multiple locations. Each data base or system may include any of various suitable security feature or module (e.g., supported by a computer server software), such as a firewall, access code, encryption, decryption, compression, decompression and/or the like. Some or all of the aforementioned components make up the peer-to-peer system of the present invention.

While various concepts have been described in detail it would be appreciated by those skilled in the art that various modifications and alternatives to those concepts could be developed in light of the overall teachings of the disclosure. Therefore, a person skilled in the art, applying ordinary skill will be able to practice the invention set forth in the claims without undue experimentation. It will additionally be appreciated that the particular concepts exposed herein are meant to be illustrative only and not limiting to the scope of the invention, which is to be given the full breath of the appended claims and any equivalents thereof.

What is claimed is:

1. A real estate data display system comprising:
real estate data obtained from an aggregated source of real estate data; a repository storage area for receiving first real estate data pertaining to a first geographic region and second real estate data pertaining to a second geographic region;
the first real estate data segmented from the second real estate data within the repository storage area;
a first dashboard interface to enable a first broker to maintain control of the first real estate data and a second dashboard interface to enable a second broker to maintain control of the second real estate data; and
a widget insertable into a browser, the widget programmed to provide a link to the first real estate data in response to a request for data pertaining to the first geographic region wherein the request is received from a broker other than the first broker.

2. The system of claim 1 wherein the first and second real estate data is obtained from one of an internet data exchange network (IDX) and an aggregation of broker listing data.

3. The system of claim 1 wherein the repository storage area comprises divisible virtual servers and the first broker controls a first virtual server containing the first real estate data and the second broker controls a second virtual server containing the second real estate data.

4. The system of claim 3 wherein the first and second broker have ownership interest in the repository storage area.

5. The system of claim 1 wherein the first real estate data and second real estate data is contained within a server having a first segmented storage location and a second segmented storage location and the first real estate data stored in the first segmented storage location and the second real estate data stored in the second segmented storage location.

6. The system of claim 1 wherein the first and second real estate data is normalized so that data fields of the first real estate date is uniform to data fields of the second real estate data.

7. The system of claim 1 where in the widget is uploaded to a browser controlled by the first broker and the widget displays a drop-down menu in the browser, the drop-down menu displaying categories of geographic regions consisting of one of a state, territory, providence, city, village, town, neighborhood and subdivision.

8. The system of claim 7 wherein the geographic regions include: 1) state; and 2) city; only in that sequence so that a subset of the real estate listing data may be obtained from the repository storage area.

9. The system of claim 7 wherein each geographic region of the widget provides a link to real estate data of one of a plurality of different broker controlled data contained in the repository storage area and provides a peer-to-peer network of nationwide real estate information.

10. The system of claim 9 wherein one of the geographic regions displayed by the widget provides a link to a second broker's website by redirecting the first broker's browser to a website controlled by the second broker, wherein the real estate data controlled by the second broker may be accessed and displayed.

11. The system of claim 1 wherein a map having a cluster display is depicted on a browser and upon selection of a first cluster the browser will link to the second real estate data.

12. The system of claim 11 wherein the cluster comprises an alphanumeric symbol that represents the number of real estate properties included in the repository storage area that are geographically associated with the location of the alphanumeric symbol on the map.

13. The system of claim 12 wherein the alphanumeric symbol is surrounded by a geometric shape having a color that distinguishes the geometric shape from adjacent area of the map.

14. The system of claim 12 wherein the geographic association is a zip code.

15. The system of claim 1 wherein upon redirection of the browser to access the second real estate data by linking to the repository storage area, a new web page is displayed including indicia associated with the second broker that controls the second real estate data.

16. The system of claim 15 wherein the indicia includes one of a logo, broker name, broker symbol, trademark, trade name, branding, tradedress and fonts.

17. The system of claim 1 wherein first real estate data may include MLS listing information for properties in a selected geographic area including one of a state, territory, providence, city, village, town, neighborhood and subdivision.

18. The system of claim 1 wherein the dashboard provides the following control parameters: sectoring, formatting, coding, directing.

19. The system of claim 18 wherein the dashboard provides control parameters that allow the first broker to control the selection of an alternate broker in a preselected geographic area.

20. The system of claim 19 wherein the dashboard provides a customizable algorithm to be set by the first broker, the algorithm for selecting the alternate broker.

21. The system of claim 19 wherein the dashboard provides a default setting for selection of the alternate broker.

22. The system of claim 21 wherein the default setting is the broker having the largest number of listings in the preselected geographic area.

23. The system of claim 1 wherein the dashboard allows a broker to customize a supplemental webpage on a host site that links to the repository storage area where the broker real estate data is maintained so that upon selection of the second real estate data the browser navigates from a broker website to the repository host website and via display of the supplemental webpage the second broker that controls the second real estate data has its webpage information displayed.

24. The system of claim 1 wherein the first broker maintains actual and apparent control over the first real estate data via the first dashboard interface and the second broker maintaining actual and apparent control over the second real estate data via the second dashboard interface.

25. The system of claim 1 wherein the widget is an application programming interface (API).

26. The system of claim 1 wherein displayed properties may be selected to obtain detailed property information and a purchasing process initiated via the system.

27. A computer program product stored on a non-transitory computer readable medium, the computer program product having computer executable code instructions that are executable on a computer to display real estate data, the computer executable code instructions comprising:
first code instructions for receiving real estate data obtained from an aggregated source of real estate data;
second code instructions for receiving first real estate data pertaining to a first geographic region;
third code instructions for receiving second real estate data pertaining to a second geographic region;
fourth code instructions for segmenting the first real estate data from the second real estate data within a repository storage area;
fifth code instructions to enable a first broker to maintain control of the first real estate data;
sixth code instructions to enable a second broker to maintain control of the second real estate data; and
eighth code instructions insertable into a browser, the eighth code instructions programmed to provide a link to the first real estate data in response to a request for data pertaining to the first geographic region wherein the request is received from a broker other than the first broker.

28. The code instructions of claim 27 wherein the eighth code instructions provide a drop-down menu on the first broker webpage and display a state and then display a city and upon selection of a city, ninth code instructions link to a website of the second broker and display the second real estate data.

29. The code instructions of claim 27 wherein the dashboard allows a broker to customize a supplemental webpage on a host site that links to the repository storage area where the broker real estate data is maintained so that upon selection of the second real estate data the browser navigates from a broker website to the repository host website and via display of the supplemental webpage the second broker that controls the second real estate data has its webpage information displayed.

30. The code instructions of claim 27 wherein the eighth code instructions provide an API widget that provides a link to a second broker's website by redirecting the first broker's browser to a website controlled by the second broker, wherein the real estate data controlled by the second broker may be accessed and displayed in order to initiate a purchasing process.

31. The code instruction of claim 27 wherein the fifth code instructions provide a dashboard accessible by the first broker's browser and eighth code instructions providing a widget to be loaded onto the first broker's website.
